(19) United States
(12) Patent Application Publication
(10) Pub. No.: US 2024/0304795 A1
(43) Pub. Date: Sep. 12, 2024

(54) SILICON ANODE, MANUFACTURING METHOD THEREOF, AND BATTERY COMPRISING THE SAME

(71) Applicant: UIF (University Industry Foundation), Yonsei University, Seoul (KR)

(72) Inventors: Yoon Seok JUNG, Seoul (KR); Jong Hyeok PARK, Seoul (KR); Seung Goo JUN, Gyeonggi-do (KR); Gwang Hyun LEE, Seoul (KR)

(73) Assignee: UIF (University Industry Foundation), Yonsei University, Seoul (KR)

(21) Appl. No.: 18/396,780

(22) Filed: Dec. 27, 2023

(30) Foreign Application Priority Data
Mar. 6, 2023 (KR) 10-2023-0029188

(51) Int. Cl. H01M 4/36; H01M 4/02; H01M 4/04; H01M 4/38; H01M 4/62; H01M 4/66; H01M 4/75; H01M 10/052; H01M 10/0562

(52) U.S. Cl. CPC H01M 4/366; H01M 4/0404; H01M 4/386; H01M 4/623; H01M 4/625; H01M 4/661; H01M 4/75; H01M 10/052; H01M 10/0562; H01M 2004/027; H01M 2220/20; H01M 2300/0065

(57) ABSTRACT

The present disclosure relates to a silicon anode, a method for manufacturing the same, and a battery including the same. Particularly, the silicon anode improves the interfacial contact between the silicon anode and a sulfide-based solid electrolyte layer, and thus the interfacial contact can be maintained uniformly during lithiation even under low pressure, and high delithiation capacity and coulombic efficiency can be realized.

In addition, the battery allows the lithium-alloying metal layer stacked on the anode active material layer to be applied to the silicon anode, and thus the lithium-alloying metal layer stacked on the silicon anode forms alloy with lithium in real time through the conduction of lithium ions from the solid electrolyte during lithiation/delithiation, and the silicon anode becomes soft and adhesive and shows improved interfacial contact between the lithium-alloying metal layer and the solid electrolyte layer, resulting in improvement of the life characteristics and capacity retention of the battery.

### CROSS-REFERENCE TO RELATED APPLICATION

This application claims priority to Korean Patent Application No. 10-2023-0029188 filed on Mar. 6, 2023, and all the benefits accruing therefrom under 35 U.S.C. § 119, the contents of which in its entirety are herein incorporated by reference.

### BACKGROUND

### 1. Field

The present disclosure relates to a silicon anode, a method for manufacturing the same, and a battery including the same.

### 2. Description of the Related Art

Sulfide-based solid-state batteries using a silicon anode according to the related art have disadvantageous in that the silicon anode has low ion conductivity and electron conductivity and are problematic in that they show short life characteristics due to a large change in volume of silicon during lithiation/delithiation.

To improve this, as one of the alternatives, some studies have been conducted according to the related art to ensure high discharge capacity by incorporating a solid electrolyte in a liquid state to provide an ion conduction channel in the silicon electrode. However, in this case, the interfacial resistance was increased due to the side reactions of the silicon anode with the solid electrolyte, and thus a limitation in rate characteristics was spotlighted.

As another alternative, a silicon anode was manufactured in the form of a column to induce a change in volume in the linear direction (1D) so that the life characteristics may be improved. However, in this case, chemical vapor deposition should be used, and thus there still has been a limitation in terms of commercialization due to the high cost and high difficulty of the process.

Recently, research and development have been conducted about solid-state batteries using a silicon anode free from a solid electrolyte and a conductive material and the performance thereof. It is reported that when a silicon anode and a solid electrolyte form an electrochemically stable interface, a stable interface, which offsets low ion conductivity and electron conductivity through the softness of the silicon anode, is formed upon the lithiation, thereby providing a solid-state battery with improved life characteristics. However, this was merely the result of performance under the application of unrealistic high pressure, and there still has been a limitation of low delithiation capacity during the driving under low pressure.

Therefore, it is essential to develop technologies about silicon anodes to commercialize solid-state batteries having higher energy density as compared to the conventional liquid electrolyte. In addition, there is a need for technological studies to realize lithiation/delithiation performance under the application of low pressure by reducing such high driving pressure to a commercially available range.

### REFERENCES

### Patent Documents

(Patent Document 1) Korean Patent Laid-Open No. 2022-0133066

### SUMMARY

To solve the above-mentioned problems, the present disclosure is directed to providing a silicon anode which shows high interfacial contact force with a sulfide-based solid electrolyte and has high delithiation capacity and coulombic efficiency.

The present disclosure is directed to providing a battery including the silicon anode according to the present disclosure.

The present disclosure is also directed to providing a device including the battery according to the present disclosure.

In addition, the present disclosure is directed to providing an electric device including the battery according to the present disclosure.

Further, the present disclosure is directed to providing a method for manufacturing a silicon anode according to the present disclosure.

In one aspect, there is provided a silicon anode including: an anode current collector; an anode active material layer formed on the anode current collector and including silicon; and a lithium-alloying metal layer formed on the anode active material layer, wherein the lithium-alloying metal layer includes at least one selected from the group consisting of silver (Ag), tin (Sn), aluminum (Al), bismuth (Bi), gold (Au), zinc (Zn), magnesium (Mg), antimony (Sb), lead (Pb), germanium (Ge), gallium (Ga), indium (In) and silicon (Si).

In another aspect, there is provided a battery including the silicon anode according to the present disclosure; a cathode including lithium metal; and a solid electrolyte layer interposed between the silicon anode and the cathode.

In still another aspect, there is provided a device which includes the battery according to the present disclosure and is any one selected from communication devices, transport devices and energy storage devices.

In still another aspect, there is provided an electric device which includes the battery according to the present disclosure and is any one selected from electric vehicles, hybrid electric vehicles, plug-in hybrid electric vehicles and electric power storage devices.

In yet another aspect, there is provided a method for manufacturing a silicon anode, including the steps of: coating an anode active material slurry including silicon on an anode current collector to form an anode active material layer; and depositing a lithium-alloying metal powder on the anode active material layer to form a lithium-alloying metal layer, wherein the lithium-alloying metal layer includes at least one selected from the group consisting of silver (Ag), tin (Sn), aluminum (Al), bismuth (Bi), gold (Au), zinc (Zn), magnesium (Mg), antimony (Sb), lead (Pb), germanium (Ge), gallium (Ga), indium (In) and silicon (Si).

The silicon anode according to the present disclosure includes a lithium-alloying metal layer formed on the anode active material layer to improve the interfacial contact between the silicon anode and a sulfide-based solid electrolyte layer. Therefore, the interfacial contact can be maintained uniformly during lithiation even under low pressure, and high delithiation capacity and coulombic efficiency can be realized.

In addition, the battery according to the present disclosure allows the lithium-alloying metal layer stacked on the anode active material layer according to the present disclosure to be applied to the silicon anode, and thus the lithium-alloying metal layer stacked on the silicon anode forms alloy with lithium in real time through the conduction of lithium ions from the solid electrolyte during lithiation/delithiation, and the silicon anode becomes soft and adhesive and shows improved interfacial contact between the lithium-alloying metal layer and the solid electrolyte layer, resulting in improvement of the life characteristics and capacity retention of the battery.

The effects of the present disclosure are not limited to the above-mentioned effects. It should be understood that the effects of the present disclosure include all effects that can be inferred from the following description.

### BRIEF DESCRIPTION OF THE DRAWINGS

FIG. 1 is a photographic image of lithium alloy after the lithium intercalation of a lithium-alloying metal layer, when a lithium-alloying metal powder used in each of Examples 1 and 2 is mixed with a lithium metal in a pre-test.

FIG. 2 is an X-ray photoelectron spectroscopic (XPS) graph of lithium alloy formed through the binding of lithium-alloying metal powder with lithium metal, after the solid-state battery using the silicon anode according to Example 1 is charged/discharged.

FIG. 3 is a schematic view (left image) of the silicon anode according to Example 1, and a graph (b) illustrating the half-cell discharge capacity and life characteristics of the solid-state battery using the silicon anode according to each of Example 1 and Comparative Example 1, before and after the interface coating of the lithium-alloying metal layer.

FIG. 4 is a graph (a) illustrating the charge/discharge performance of the NCM/Si full-cell obtained by using the silicon anode according to each of Example 1 and Comparative Example 1, and a graph (b) illustrating the capacity retention and coulombic efficiency depending on cycle number.

FIG. 5 shows a graph (a, b) illustrating the charge/discharge performance of the NCM/Si full-cell obtained by using the silicon anode according to each of Example 2 and Comparative Example 2.

FIG. 6 is a scanning electron microscopic (SEM) image illustrating the thickness of the lithium-alloying metal layer formed on the silicon active material layer before carrying out a test for lithiation/delithiation of the silicon anode according to Example 1.

FIG. 7 illustrates the analysis result of time-of-flight secondary ion mass spectrometry (TOF-SIMs) and shows the sectional views of the silicon anode and the solid electrolyte layer, after the solid-state battery using the silicon anode according to each of Example 1 and Comparative Example 1 is discharged once.

### DETAILED DESCRIPTION

Hereinafter, particular embodiments of the present disclosure will be explained in detail.

The present disclosure relates to a silicon anode, a method for manufacturing the same and a battery including the same.

As described earlier, sulfide-based solid-state batteries using a silicon anode according to the related art have disadvantageous in that the silicon anode has low ion conductivity and electron conductivity and are problematic in that they show short life characteristics due to a large change in volume of silicon during lithiation/delithiation. To improve this, there have been made various attempts, such as mixing a solid electrolyte in a liquid state into a silicon anode, manufacturing a silicon anode in the form of a column to induce a change in volume in the linear direction, or the like. However, despite such attempts, there still has been a limitation in commercialization due to the generation of side reactions between the silicon anode and the solid electrolyte or a high-cost high-difficulty process.

Under these circumstances, according to the present disclosure, a silicon anode is obtained by forming a lithium-alloying metal layer on an anode active material layer to improve the interfacial contact between the silicon anode and the sulfide-based solid electrolyte. In this manner, the interfacial contact can be maintained uniformly during lithiation even under low pressure, and high delithiation capacity and coulombic efficiency can be realized.

In addition, the battery according to the present disclosure allows the lithium-alloying metal layer stacked on the anode active material layer according to the present disclosure to be applied to the silicon anode, and thus the lithium-alloying metal layer stacked on the silicon anode forms alloy with lithium in real time through the conduction of lithium ions from the solid electrolyte during lithiation/delithiation, and the silicon anode becomes soft and adhesive and shows improved interfacial contact between the lithium-alloying metal layer and the solid electrolyte layer, resulting in improvement of the life characteristics and capacity retention of the battery.

Particularly, in one aspect of the present disclosure, there is provided a silicon anode including: an anode current collector; an anode active material layer formed on the anode current collector and including silicon; and a lithium-alloying metal layer formed on the anode active material layer, wherein the lithium-alloying metal layer includes at least one selected from the group consisting of silver (Ag), tin (Sn), aluminum (Al), bismuth (Bi), gold (Au), zinc (Zn), magnesium (Mg), antimony (Sb), lead (Pb), germanium (Ge), gallium (Ga), indium (In) and silicon (Si).

The anode current collector may be at least one selected from the group consisting of copper foil, nickel, stainless steel and aluminum, preferably copper foil.

The anode active material layer may further include a conductive material, and the conductive material may be at least one selected from the group consisting of carbon nanotubes (CNTs), Ketjen black, carbon black, acetylene black, Super P, graphite and graphene, preferably at least one selected from the group consisting of carbon nanotubes, carbon black and graphite, and most preferably carbon nanotubes.

The anode active material layer may further include a binder, and the binder may be at least one selected from the group consisting of polyvinylidene difluoride, polytetrafluoroethylene, polyethylene oxide, butadiene rubber, nitrile butadiene rubber and carboxymethyl cellulose, preferably polyvinylidene difluoride, polytetrafluoroethylene or a mixture thereof, and most preferably polyvinylidene difluoride.

The mixing ratio of silicon, the conductive material and the binder of the anode active material layer may be 99:1:1 to 50:25:25, preferably 90:5:5 to 60:20:20, and most preferably 80:10:10 to 70:15:15, on the weight basis.

The lithium-alloying metal in the lithium-alloying metal layer means a metal capable of forming alloy with lithium during lithiation/delithiation. As the criteria for selecting an applicable lithium-alloying metal, it is important to use a lithium-alloying metal having an electric potential higher than the electric potential of the silicon anode, since the electric potential is decreased as the lithium content is increased during lithiation.

Under the criteria, particular examples of the lithium-alloying metal layer that may be used according to the present disclosure may include at least one selected from the group consisting of silver (Ag), tin (Sn), aluminum (Al), bismuth (Bi), gold (Au), zinc (Zn), magnesium (Mg), antimony (Sb), lead (Pb), germanium (Ge), gallium (Ga), indium (In) and silicon (Si), preferably silver (Ag), tin (Sn) or a mixture thereof, and most preferably silver (Ag).

Particularly, silver (Ag) shows significantly high electrical conductivity as compared to the other metals and has a higher electrochemical potential as compared to the silicon-containing anode active material layer during the lithium intercalation through the lithiation/delithiation, when forming alloy with lithium ions, and thus allows intercalation of a large amount of lithium first. In addition, silver shows physically soft characteristics during the lithium intercalation and can function to bind the solid electrolyte with the silicon anode.

The lithium-alloying metal layer may have a thickness of 1-500 nm, preferably 10-300 nm, more preferably 20-100 nm, and most preferably 30-80 nm. Particularly, when the lithium-alloying metal layer has a thickness of less than 1 nm, the interfacial binding force between the silicon anode and the solid electrolyte may be degraded. On the other hand, when the lithium-alloying metal layer has a thickness of larger than 500 nm, the electron and lithium-ion migration path becomes longer due to such a large thickness of the lithium-alloying metal layer to cause generation of irreversibility and interfacial resistance, resulting in a rapid drop in discharge capacity.

The lithium-alloying metal may be used in an amount of 0.1-50 wt %, preferably 1-30 wt %, more preferably 2-10 wt %, and most preferably 3-8 wt %, based on 100 wt % of the silicon anode. When the content of the lithium-alloying metal is less than 0.1 wt %, the interfacial adhesion may be degraded. On the other hand, when the content of the lithium-alloying metal is larger than 50 wt %, the electron and lithium-ion migration path becomes longer due to such a large thickness of the lithium-alloying metal layer to cause generation of irreversibility and interfacial resistance, resulting in a rapid drop in discharge capacity.

The lithium-alloying metal layer may include silver (Ag), tin (Sn) or a mixture thereof and may have a thickness of 30-80 nm, and the lithium-alloying metal may be used in an amount of 3-8 wt % based on 100 wt % of the silicon anode. Herein, when the lithium-alloying metal layer satisfies any one of the conditions of the type, thickness range and lithium-alloying metal content range, application of the lithium-alloying metal layer to a battery may provide high delithiation capacity under a low driving pressure of 10-20 Mpa and may stabilize the interfacial instability with the solid electrolyte caused by the volumetric swelling of the silicon anode during the lithium-ion intercalation and deintercalation.

Particularly, although it is not clearly described in the following Examples and Comparative Example, a battery was manufactured through a conventional method by using the silicon anode obtained by applying the following eight conditions in the method for manufacturing a silicon anode according to the present disclosure. Then, the battery was charged and discharged 500 times under a low driving voltage environment of 5 MPa or less, and the side reactions between the silicon anode and the sulfide-based solid electrolyte, interfacial resistance and the electrochemical stability and energy density of the battery were evaluated.

As a result, unlike the other conditions and numerical ranges, it is shown that when all of the following eight conditions are satisfied, defective phenomena caused by the side reactions and interfacial contact between the silicon anode and the sulfide-based electrolyte in the battery occur little, and the battery shows significantly high electrochemical stability even under a low driving pressure environment of 5 MPa or less, has high energy density and significantly improved capacity and life characteristics.

1) The anode current collector is copper foil, 2) the anode active material layer further includes a conductive material, and the conductive material is carbon nanotubes, 3) the anode active material layer further includes a binder, and the binder is polyvinylidene difluoride, 4) the mixing ratio of silicon:conductive material:binder in the anode active material layer is 80:10:10 to 70:15:15 on the weight basis, 5) the lithium-alloying metal layer is formed by direct current (DC) sputtering, 6) the lithium-alloying metal layer includes silver (Ag), 7) the lithium-alloying metal layer has a thickness of 30-80 nm, and 8) the lithium-alloying metal may be used in an amount of 3-8 wt % based on 100 wt % of the silicon anode.

However, if any one of the above eight conditions is not satisfied, side reactions occur between the anode active material and the sulfide-based electrolyte in the electrode, after repeating lithiation/delithiation 250 times, under a low driving pressure environment of 5 MPa or less, and cracks are generated due to the strong interfacial resistance between the silicon anode and the solid electrolyte surface. In addition, it is shown that the silicon anode is partially lost, and the capacity and life characteristics of the electrode is degraded rapidly due to the separation of the solid electrolyte from the silicon anode.

In another aspect of the present disclosure, there is provided a battery including: the silicon anode according to the present disclosure; a cathode including a lithium metal; and a solid electrolyte layer interposed between the silicon anode and the cathode.

The solid electrolyte layer may include a sulfide-based solid electrolyte, but is not limited thereto.

The battery may include a lithium alloy layer formed at the interface between the lithium-alloying metal layer of the silicon anode and the solid electrolyte layer through the binding of the lithium-alloying metal layer with lithium ions migrated from the cathode after lithiation/delithiation.

The lithium alloy layer may include LiₓM_{y} (wherein M represents at least one selected from the group consisting of Ag, Sn, Al, Bi, Au and Zn, x represents a real number of 0.1-30, and y is a real number of 1-10).

Particular examples of the lithium alloy layer may include at least one selected from the group consisting of Li₉Ag₄, LiZn and Li₁₇Sn₄, but are not limited thereto.

Even when a lithium-alloying metal layer is applied to a conventional liquid electrolyte, the capacity and life characteristics of a battery are not improved significantly. However, the battery of the present disclosure can provide improved capacity and life characteristics by applying the silicon anode including a lithium-alloying metal layer to the solid electrolyte.

The battery may be a solid-state battery or a lithium secondary battery, preferably a solid-state battery.

In another aspect of the present disclosure, there is provided a device which includes the battery according to the present disclosure and is any one selected from communication devices, transport devices and energy storage devices.

In still another aspect of the present disclosure, there is provided an electric device which includes the battery according to the present disclosure and is any one selected from electric vehicles, hybrid electric vehicles, plug-in hybrid electric vehicles and electric power storage devices.

In yet another aspect of the present disclosure, there is provided a method for manufacturing a silicon anode, including the steps of: coating an anode active material slurry including silicon on an anode current collector to form an anode active material layer; and depositing a lithium-alloying metal powder on the anode active material layer to form a lithium-alloying metal layer, wherein the lithium-alloying metal layer includes at least one selected from the group consisting of silver (Ag), tin (Sn), aluminum (Al), bismuth (Bi), gold (Au), zinc (Zn), magnesium (Mg), antimony (Sb), lead (Pb), germanium (Ge), gallium (Ga), indium (In) and silicon (Si).

The step of forming a lithium-alloying metal layer may be carried out through any one process selected from the group consisting of direct current (DC) sputtering (Auto 108 Model available from Cressington Sputter Co.), radiofrequency (RF) sputtering, thermal evaporation and physical vapor deposition processes, preferably DC sputtering or thermal evaporation process.

The lithium-alloying metal layer may have a thickness of 1-500 nm, preferably 10-300 nm, more preferably 20-100 nm, and most preferably 30-80 nm.

The lithium-alloying metal may be used in an amount of 0.1-50 wt %, preferably 1-30 wt %, more preferably 2-10 wt %, and most preferably 3-8 wt %, based on 100 wt % of the silicon anode.

Preferably, the anode current collector may include copper (Cu) foil, the anode active material slurry may further include a conductive material, and the conductive material is carbon nanotubes, the anode active material slurry may further include a binder, and the binder is polyvinylidene difluoride, the mixing ratio of silicon:conductive material:binder in the anode active material layer may be 80:10:10 to 70:15:15 on the weight basis, the step of forming a lithium-alloying metal layer may be carried out by direct current (DC) sputtering, the lithium-alloying metal layer may include silver (Ag), the lithium-alloying metal layer may have a thickness of 30-80 nm, and the lithium-alloying metal may be used in an amount of 3-8 wt % based on 100 wt % of the silicon anode.

As described above, the silicon anode for a battery according to the present disclosure improves the interfacial contact between the silicon anode and the sulfide-based solid electrolyte, and thus the interfacial contact can be maintained uniformly during charge even under low pressure, and high discharge capacity and coulombic efficiency can be realized.

In addition, the battery according to the present disclosure uses the silicon anode including the lithium-alloying metal layer formed on the anode active material layer according to the present disclosure, and thus the lithium-alloying metal layer stacked on the silicon anode forms alloy with lithium in real time through the conduction of lithium ions from the solid electrolyte during lithiation/delithiation, and the silicon anode becomes soft and adhesive and shows improved interfacial contact between the lithium-alloying metal layer and the solid electrolyte layer, resulting in improvement of the life characteristics and capacity retention of the battery.

Hereinafter, the present disclosure will be explained in more detail with reference to examples, but the scope of the present disclosure is not limited thereto.

### EXAMPLE 1: MANUFACTURE OF SILICON ANODE

First, silicon (Si) as an anode active material, carbon nanotubes as a conductive material and polyvinylidene difluoride (PVDF) as a binder were mixed in N-methyl-2-pyrrolidone (NMP) as a solvent at a weight ratio of 70:15:15 to prepare an anode active material slurry. Next, the anode active material slurry was applied onto a copper current collector having a thickness of 10 μm as an anode current collector and vacuum dried at 80° C. to form an anode active material layer. Then, a silver (Ag) coating layer was formed by using a silver (Ag) target (average size: 1-5 μm) as a lithium-alloying metal through the deposition using direct current (DC) sputtering under vacuum to obtain a silicon anode. Herein, the lithium-alloying metal was used in an amount of 4 wt % based on 100 wt % of the silicon anode. In addition, the anode active material layer had a thickness of 9-10 μm, and the lithium-alloying metal layer had a thickness of 36.88 nm.

### EXAMPLE 2: MANUFACTURE OF SILICON ANODE

A silicon anode was obtained in the same manner as Example 1, except that tin (Sn) was deposited as a lithium-alloying metal layer, wherein a tin (Sn) coating layer was formed by carrying out pre-lithiation.

### COMPARATIVE EXAMPLE 1: MANUFACTURE OF SILICON ANODE

A silicon anode was obtained in the same manner as Example 1, except that no lithium-alloying metal layer was formed.

### COMPARATIVE EXAMPLE 2: MANUFACTURE OF SILICON ANODE

A silicon anode was obtained in the same manner as Example 2, except that no lithium-alloying metal layer was formed.

### TEST EXAMPLE 1: ELECTROCHEMICAL ANALYSIS AFTER LITHIUM INTERCALATION

The silicon anode obtained from each of Examples 1 and 2 was used. First, 150 mg of a sulfide-based solid electrolyte (Li₆PS₅Cl) was introduced to a solid-state battery mold and pressed under 1 ton. In the case of a half-cell, 100 mg of an opposite pole electrode including Li—In mixed with a solid electrolyte was introduced to a counter electrode, the silicon anode obtained from each of Examples 1 and 2 was introduced to a working electrode disposed at the opposite side, and then pressing was carried out at once under 5 tons. Then, a solid-state battery was obtained through the binding under a pressure of 15 MPa. The resultant solid-state battery was charged and discharged under the conditions of 30° C., a current of 0.2 C (0.63 mA/cm², 1 C=3500 mA/g), and voltage analysis was carried out after the electrochemical lithium intercalation of the silicon with the lithium-alloying metal layer.

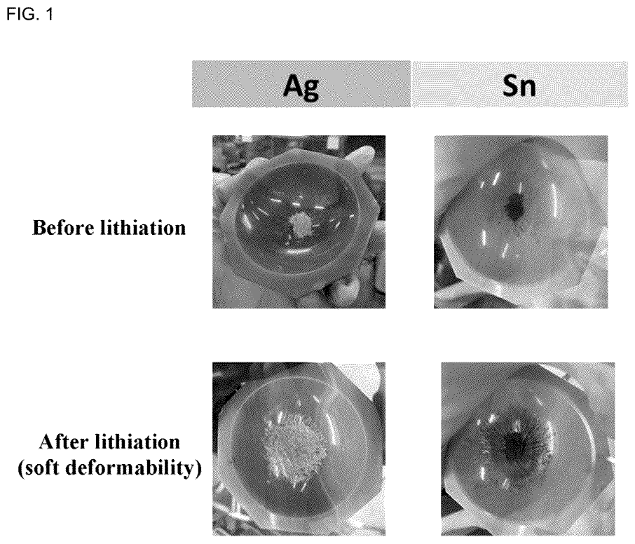

FIG. 1 is a photographic image of lithium alloy after the lithium intercalation of a lithium-alloying metal layer, when a lithium-alloying metal powder used in each of Examples 1 and 2 is mixed with lithium metal in a pre-test. Referring to FIG. 1, in the case of Examples 1 and 2, lithium alloys of Li₉Ag₄ and Li₁₇Sn₄ are formed in Examples 1 and 2, respectively, due to lithium intercalation. The lithium alloys show soft deformability due to the low hardness after lithiation.

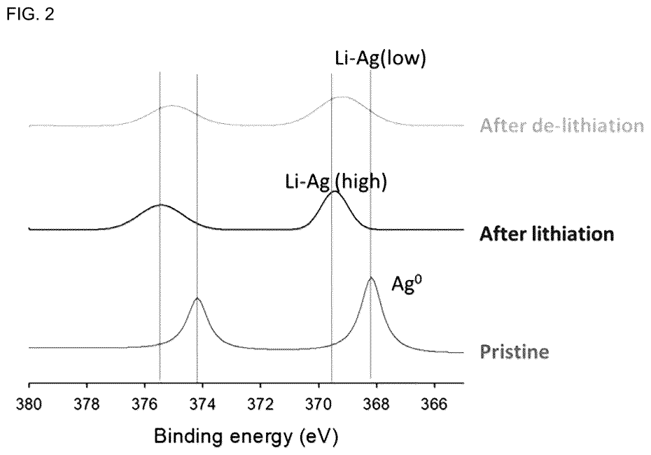

FIG. 2 is an X-ray photoelectron spectroscopic (XPS) graph of lithium alloy formed through the binding of lithium-alloying metal powder with lithium metal, after the solid-state battery using the silicon anode according to Example 1 is charged/discharged. Referring to FIG. 2, it can be seen that Ag is also alloyed upon the lithiation to silicon (Si) to cause a shift toward a higher binding energy and Ag also undergoes delithiation upon the delithiation from silicon, but the lithium alloy form is partially maintained and is not returned to the original Ag state. This suggests that the lithium alloy layer maintaining soft characteristics in the state of lithium alloy can retain the contact of the solid electrolyte with the silicon anode.

It can be also seen that lithium alloy compounds of Li₉Ag₄ and Li₂₂Si₅ are formed in Examples 1 and 2, respectively, at the interface between the anode active material layer and the lithium-alloying metal layer due to the lithium intercalation after the solid-state battery is charged/discharged, and Li₉Ag₄ shows a higher action potential as compared to Li₁₅Ag₄ as a pre-phase of Li₂₂Si₅ phase.

### TEST EXAMPLE 2: ANALYSIS OF CAPACITY RETENTION

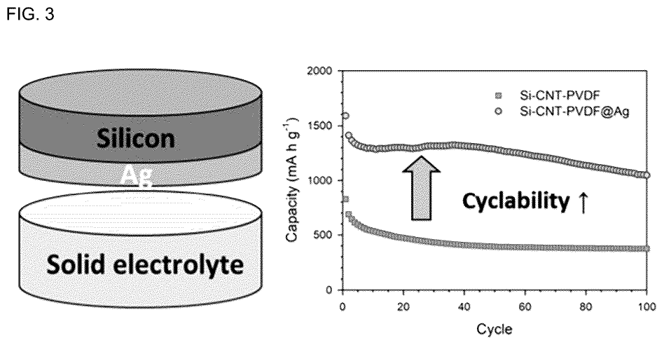

The silicon anode obtained from each of Example 1 and Comparative Example 1 was used to manufacture a half-cell solid-state battery in the same manner as Test Example 1. Next, the resultant half-cell was charged and discharged under the conditions of 30° C., a current of 0.2 C (0.63 mA/cm², 1 C=3500 mA/g) 100 times. Then, each half-cell was analyzed in terms of the discharge capacity before and after the interface coating. The results are shown in FIG. 3.

FIG. 3 is a schematic view (a) of the silicon anode according to Example 1, and a graph (b) illustrating the half-cell discharge capacity and life characteristics of the solid-state battery using the silicon anode according to each of Example 1 and Comparative Example 1, before and after the interface coating of the lithium-alloying metal layer.

Referring to (a) of FIG. 3, the silicon anode shows a structure in which a silver (Ag) coating layer is formed on one surface of the anode active material layer (silicon), and a solid electrolyte layer is disposed on the silver coating layer. Referring to (b) of FIG. 3, it can be seen that Example 1 (Si-CNT-PVDF@Ag) shows a significantly high initial discharge capacity of about 1400 mAh/g, maintains a high discharge capacity for a long time during the repetition of 100 charge/discharge cycles and has a capacity retention of 95% or more. On the other hand, Comparative Example 1 shows a significantly low initial discharge capacity of about 700 mAh/g, which corresponds to a half of the initial discharge capacity of Example 1 or less. In addition, Comparative Example 1 shows a low discharge capacity continuously and a decrease in discharge capacity during the repetition of 100 charge/discharge cycles.

### TEST EXAMPLE 3: ANALYSIS OF CHARGE/DISCHARGE PERFORMANCE AND COULOMBIC EFFICIENCY

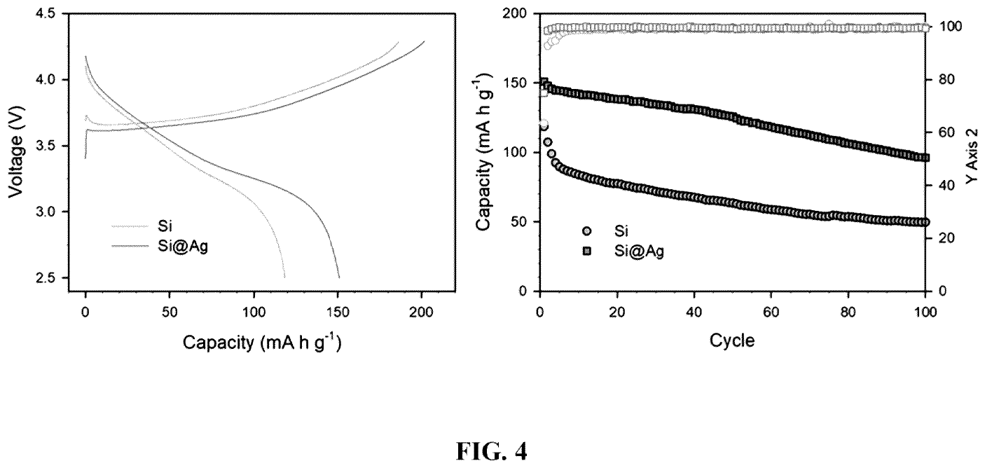

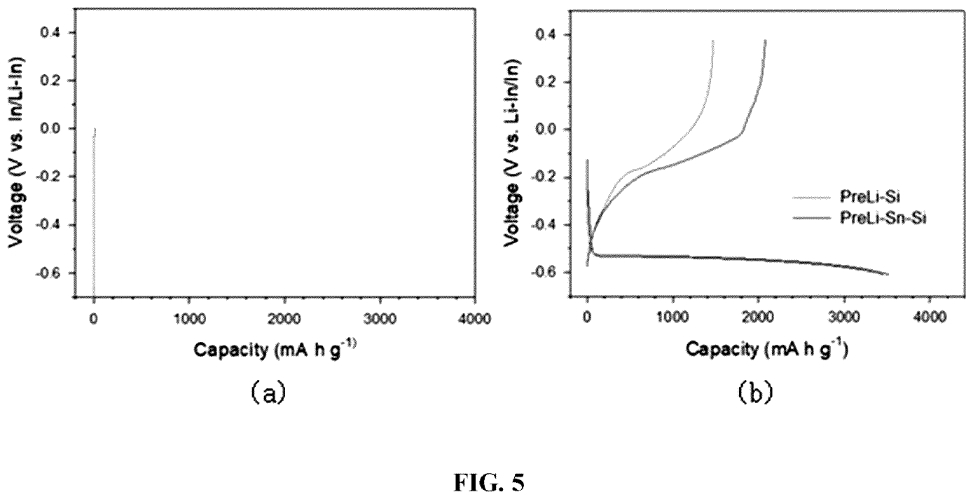

The silicon anode according to each of Examples 1 and 2 and Comparative Examples 1 and 2 was used to obtain a full cell. Particularly, a nickel cobalt manganese (NCM) composite cathode material was introduced to a working electrode, the silicon anode according to each of Examples 1 and 2 and Comparative Examples 1 and 2 was introduced to a counter electrode, and pressing was carried out under 5 tons. In this manner, a solid-state battery of NCM/Si full cell was obtained. Herein, the silicon anode according to each of Example 2 and Comparative Example 2 was preliminarily lithiated. The resultant NCM/Si full cell was charged and discharged 100 times under the conditions of 30° C., a current of 0.2 C (0.63 mA/cm², 1 C=3500 mA/g). Then, the initial charge/discharge performance, capacity retention depending on cycle number and coulombic efficiency were analyzed. The results are shown in FIG. 4 and FIG. 5.

FIG. 4 is a graph (a) illustrating the charge/discharge performance of the NCM/Si full-cell obtained by using the silicon anode according to each of Example 1 and Comparative Example 1, and a graph (b) illustrating the capacity retention and coulombic efficiency depending on cycle number. Referring to (a) of FIG. 4, Example 1 (Si70@Ag) shows improved charge capacity and discharge capacity as compared to Compared to Comparative Example 1 (Si70).

In addition, referring to (b) of FIG. 4, both Example 1 (Si70@Ag) and Comparative Example 1 (Si70) show a high coulombic efficiency. Further, it can be seen that while Example 1 (Si70@Ag) shows a slight drop in discharge capacity as the cycle number increases, Comparative Example 1 (Si70) shows a rapid drop in capacity retention as the cycle number increases.

FIG. 5 shows a graph (a, b) illustrating the charge/discharge performance of the NCM/Si full-cell obtained by using the silicon anode according to each of Example 2 and Comparative Example 2. Referring to FIG. 5, in the case of Comparative Example 2, it can be seen that the solid-state battery using the silicon anode including no tin (Sn) layer shows insufficient charge/discharge performance.

On the contrary, in the case of silicon anode including a tin (Sn) layer coated on the anode active material layer according to Example 2, it can be seen that the pre-lithiated silicon anode provides excellent charge/discharge performance equivalent to the charge/discharge performance of Example 1.

The above result suggests that the silicon anode according to Example 2, unlike the silicon anode according to Example 1, does not allow the battery to work due to the poor contact of the silicon anode with the solid electrolyte, when it is not pre-lithiated, but shows the effects equivalent to the silicon anode having a silver (Ag) layer according to Example 1 merely when both the tin layer coating and pre-lithiation are satisfied.

### TEST EXAMPLE 4: ANALYSIS OF INTERFACE OF SILICON ANODE WITH SOLID ELECTROLYTE LAYER AFTER LITHIATION/DELITHIATION

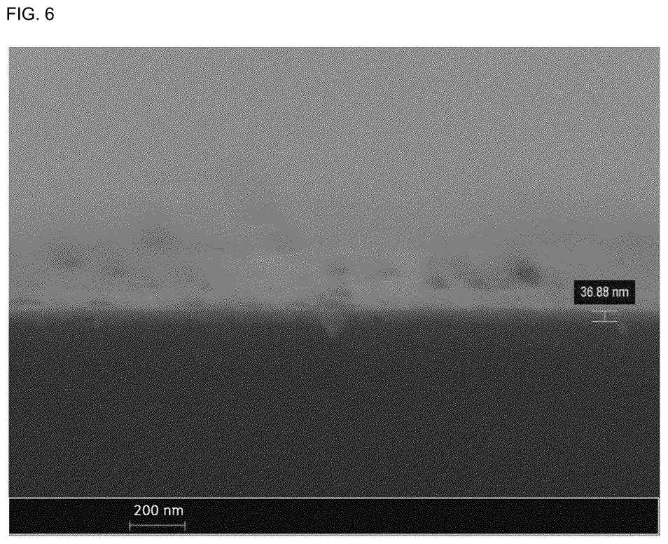

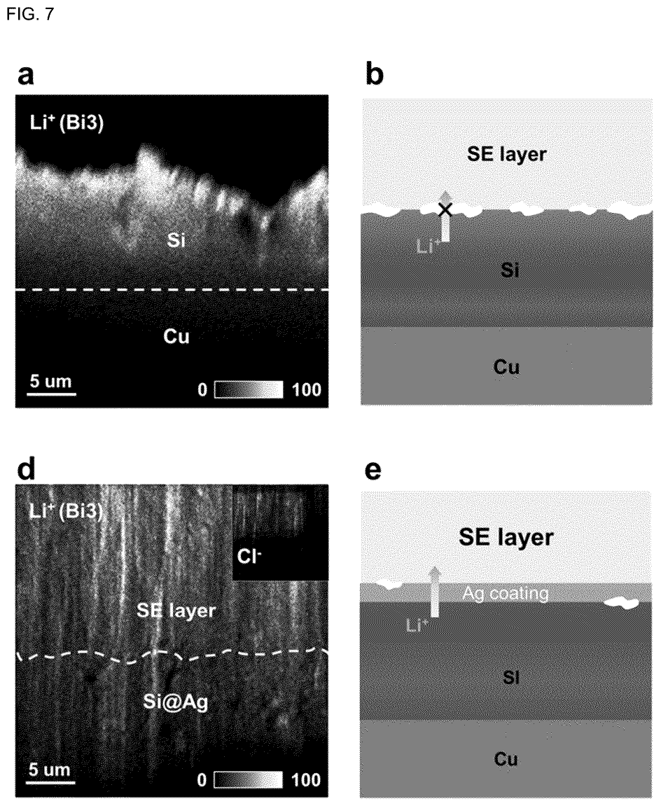

The silicon anode according to each of Example 1 and Comparative Example 1 was used to obtain a solid-state battery in the same manner as Test Example 3, and the solid-state battery was charged/discharged once. After the battery was charged/discharged, the interface of the silicon anode with the solid electrolyte layer was analyzed. The results are shown in FIG. 6 and FIG. 7.

FIG. 6 is a scanning electron microscopic (SEM) image illustrating the thickness of the lithium-alloying metal layer formed on the silicon active material layer before carrying out a test for lithiation/delithiation of the silicon anode according to Example 1. Referring to FIG. 6, it can be seen that the lithium-alloying metal layer is formed on the silicon active material layer to a thickness of 36.88 nm.

FIG. 7 illustrates the analysis result of time-of-flight secondary ion mass spectrometry (TOF-SIMs) and shows the sectional views of the silicon anode and the solid electrolyte layer, after the solid-state battery using the silicon anode according to each of Example 1 and Comparative Example 1 is discharged once. Referring to FIG. 7, in the case of Comparative Example 1, since the silicon anode has no lithium-alloying metal layer formed on the silicon active material layer, the silicon active material layer is separated from the solid electrolyte and interfacial separation occurs between the silicon anode and the solid electrolyte layer, and thus delithiation cannot be performed smoothly. In addition, a high concentration of lithium metal is observed on the surface of the silicon anode.

On the contrary, in the case of Example 1, it can be seen that a lithium-alloying metal layer is formed on the silicon active material layer and the solid electrolyte layer is attached well to the lithium-alloying metal layer. It can be also seen that no interfacial separation occurs between the silicon anode and the solid electrolyte layer to allow smooth delithiation, and thus there is no difference in lithium concentration gradient in the silicon anode.

What is claimed is:

1. A silicon anode comprising:
an anode current collector;
an anode active material layer formed on the anode current collector and comprising silicon; and
a lithium-alloying metal layer formed on the anode active material layer,
wherein the lithium-alloying metal layer comprises at least one selected from the group consisting of silver (Ag), tin (Sn), aluminum (Al), bismuth (Bi), gold (Au), zinc (Zn), magnesium (Mg), antimony (Sb), lead (Pb), germanium (Ge), gallium (Ga), indium (In) and silicon (Si).

2. The silicon anode according to claim 1, wherein the anode active material further comprises a conductive material, and
the conductive material is at least one selected from the group consisting of carbon nanotubes (CNTs), Ketjen black, carbon black, acetylene black, Super P, graphite and graphene.

3. The silicon anode according to claim 1, wherein the anode active material layer further comprises a binder, and
the binder is at least one selected from the group consisting of polyvinylidene difluoride, polytetrafluoroethylene, polyethylene oxide, butadiene rubber, nitrile butadiene rubber and carboxymethyl cellulose.

4. The silicon anode according to claim 1, wherein the lithium-alloying metal layer has a thickness of 1-500 nm.

5. The silicon anode according to claim 1, wherein the lithium-alloying metal is used in an amount of 1-50 wt % based on 100 wt % of the silicon anode.

6. The silicon anode according to claim 1, wherein the lithium-alloying metal layer comprises silver (Ag), tin (Sn) or a mixture thereof and has a thickness of 30-80 nm, and the lithium-alloying metal is used in an amount of 3-8 wt % based on 100 wt % of the silicon anode.

7. The silicon anode according to claim 1, wherein the anode current collector is copper foil,
the anode active material layer further comprises a conductive material, and the conductive material is carbon nanotubes,
the anode active material layer further comprises a binder, and the binder is polyvinylidene difluoride,
the mixing ratio of silicon:conductive material:binder in the anode active material layer is 80:10:10 to 70:15:15 on the weight basis,
the lithium-alloying metal layer is formed by direct current (DC) sputtering,
the lithium-alloying metal layer comprises silver (Ag),
the lithium-alloying metal layer has a thickness of 30-80 nm, and
the lithium-alloying metal is used in an amount of 3-8 wt % based on 100 wt % of the silicon anode.

8. A battery comprising:
the silicon anode as defined in any one of claim 1;
a cathode comprising lithium metal; and
a solid electrolyte layer interposed between the silicon anode and the cathode.

9. The battery according to claim 8, which further comprises a lithium alloy layer formed at the interface between the silicon anode and the solid electrolyte layer through the binding of the lithium-alloying metal layer with lithium ions migrated from the cathode after lithiation/delithiation.

10. The battery according to claim 9, wherein the lithium alloy layer comprises LiₓM_{y} (wherein M represents at least one selected from the group consisting of Ag, Sn, Al, Bi, Au and Zn, x represents a real number of 0.1-30, and y is a real number of 1-10).

11. A device which comprises the battery as defined in claim 8 and is any one selected from communication devices, transport devices and energy storage devices.

12. An electric device which comprises the battery as defined in claim 8 and is any one selected from electric vehicles, hybrid electric vehicles, plug-in hybrid electric vehicles and electric power storage devices.

13. A method for manufacturing a silicon anode, comprising the steps of:
coating an anode active material slurry comprising silicon on an anode current collector to form an anode active material layer; and
depositing a lithium-alloying metal powder on the anode active material layer to form a lithium-alloying metal layer,
wherein the lithium-alloying metal layer comprises at least one selected from the group consisting of silver (Ag), tin (Sn), aluminum (Al), bismuth (Bi), gold (Au), zinc (Zn), magnesium (Mg), antimony (Sb), lead (Pb), germanium (Ge), gallium (Ga), indium (In) and silicon (Si).

14. The method for manufacturing a silicon anode according to claim 13, wherein the step of forming a lithium-alloying metal layer is carried out through any one process selected from the group consisting of direct current (DC) sputtering, radiofrequency (RF) sputtering, thermal evaporation and physical vapor deposition processes.

15. The method for manufacturing a silicon anode according to claim 13, wherein the lithium-alloying metal layer has a thickness of 1-500 nm.

16. The method for manufacturing a silicon anode according to claim 13, wherein the lithium-alloying metal is used in an amount of 0.1-50 wt % based on 100 wt % of the silicon anode.

17. The method for manufacturing a silicon anode according to claim 13, wherein the anode current collector is copper (Cu) foil,
the anode active material slurry further comprises a conductive material, and the conductive material is carbon nanotubes,
the anode active material slurry further comprises a binder, and the binder is polyvinylidene difluoride,
the mixing ratio of silicon:conductive material:binder in the anode active material layer is 80:10:10 to 70:15:15 on the weight basis,
the step of forming a lithium-alloying metal layer is carried out by direct current (DC) sputtering,
the lithium-alloying metal layer comprises silver (Ag),
the lithium-alloying metal layer has a thickness of 30-80 nm, and
the lithium-alloying metal is used in an amount of 3-8 wt % based on 100 wt % of the silicon anode.
